(19) United States
(12) Patent Application Publication
(10) Pub. No.: US 2015/0241962 A1
(43) Pub. Date: Aug. 27, 2015

(54) USER PRESENCE DETECTION IN MOBILE DEVICES

(71) Applicant: Vid Scale, Inc., Wilmington, DE (US)

(72) Inventors: Yuriy Reznik, San Diego, CA (US); Zhifeng Chen, San Diego, CA (US); Rahul Vanam, San Diego, CA (US); Eduardo Asbun, San Diego, CA (US); Varshita Parthasarathy, Folsom, CA (US)

(73) Assignee: Vid Scale, Inc., Wilmington, DE (US)

(21) Appl. No.: 14/437,495

(22) PCT Filed: Oct. 22, 2013
(86) PCT No.: PCT/US13/66122

§ 371 Date: Apr. 21, 2015

Related U.S. Application Data
(60) Provisional application No. 61/717,055, filed on Oct. 22, 2012.
(60) Provisional application No. 61/720,717, filed on Oct. 31, 2012.

(51) Int. Cl. G06F 3/01; G06F 3/0346

(52) U.S. Cl. CPC G06F 3/012; G06F 3/0346

(57) ABSTRACT

Systems, methods, and instrumentalities may be provided for determining user presence in a mobile device, e.g., using one or more sensors. A mobile device may detect a face. The mobile device may determine a face distance that is associated with the detected face. The mobile device may determine a motion status that may indicate whether the mobile device is in motion or is at rest. The mobile device may use information from one or more sensors to determine the motion status. The mobile device may confirm a user presence based on the face distance and the motion status.

### CROSS REFERENCE TO RELATED APPLICATIONS

This application claims the benefit of U.S. Provisional Patent Application Nos. 61/717,055 filed on Oct. 22, 2012, and 61/720,717 filed on Oct. 31, 2012, the contents of which are hereby incorporated by reference herein.

### BACKGROUND

Mobile devices, for example, tablet computers, smartphones, laptop computers etc. may be provided with a number of sensors. Since a mobile device may be easily transported from place to place, user detection and distance estimation of a user's face in mobile devices may be a challenging task. The data provided by embedded sensors, e.g., cameras may not be accurate. Existing detection algorithms (e.g., Viola-Jones face detector) may result in false alarms or failures to detect a user in many practical situations.

### SUMMARY

Systems, methods, and instrumentalities may be provided for determining user presence in a mobile device, e.g., using one or more sensors. A mobile device may detect a face. The mobile device may determine a face distance that may be associated with the detected face. The face distance may be calculated based on one or more of an interpupillary distance, a camera view angle, an angle between eyes, or an angle capturing head breadth of the detected face.

The mobile device may determine a motion status (e.g., if the mobile device is in motion or at rest). The motion status may be determined using one or more sensors in the mobile device.

The mobile device may confirm a user presence based on the face distance and the motion status. To confirm the user presence, for example, the mobile device may determine a distance threshold and compare the distance threshold to the face distance. The distance threshold may be determined based on the motion status.

### BRIEF DESCRIPTION OF THE DRAWINGS

FIG. 1 is a graph illustrating an example modeling of the calibration constant C.

FIG. 2 is a diagram illustrating an example of logic that may be used for computing ambient illuminance.

FIG. 3 is a diagram illustrating an example of a user activity detection (UAD) API and framework architecture.

FIG. 4A is a diagram illustrating an example computation of a user's distance from a screen using interpupillary distance (IDP).

FIG. 4B is a diagram illustrating an example computation of a user's distance from a screen using head scale/breadth (e.g., as may be reported by a face detector).

FIG. 5 is a diagram illustrating an example of a data structure for sensor signal processing.

FIG. 6 is a flowchart illustrating an example of fusion logic for improving the accuracy of face detection and face proximity determinations.

FIG. 7A is a system diagram of an example communications system in which one or more disclosed embodiments may be implemented.

FIG. 7B is a system diagram of an example wireless transmit/receive unit (WTRU) that may be used within the communications system illustrated in FIG. 7A.

FIG. 7C is a system diagram of an example radio access network and an example core network that may be used within the communications system illustrated in FIG. 7A.

FIG. 7D is a system diagram of another example radio access network and another example core network that may be used within the communications system illustrated in FIG. 7A.

FIG. 7E is a system diagram of another example radio access network and another example core network that may be used within the communications system illustrated in FIG. 7A.

### DETAILED DESCRIPTION

A detailed description of illustrative embodiments may be described with reference to the various Figures. Although this description provides a detailed example of possible implementations, it should be noted that the details are intended to be exemplary and in no way limit the scope of the application.

Systems, methods, instrumentalities may be provided to measure ambient light using a camera (e.g., a front-facing camera or a rear-facing camera) in a device (e.g., a mobile device) for an improved user experience (e.g., an improved rendering and streaming of video). Cameras (e.g., standalone cameras, built-in cameras in smartphones, tablets and laptops, etc.) may have integrated automatic exposure capability. When a photograph is taken by a camera, the camera exposure time, aperture, and ISO speed parameters may be adjusted (e.g., automatically adjusted) to achieve a balanced distribution of colors (or gray levels) in the photograph. The adjusted values (e.g., automatically adjusted values) including, for example, exposure time, aperture, and ISO speed may be used to calculate/measure/deduce an ambient light parameter (e.g., scene illuminance) present when the picture was taken.

The calculated amount of scene illuminance may be used by a mobile device (e.g., smartphone, tablet, laptop, camera, etc.) for improving a multimedia application, for example, video streaming, video conferencing, mobile gaining applications, etc. For example, an ambient light parameter (e.g., illuminance) may be used by a mobile device (e.g., via an application) to alter a user interface of the application (e.g., text size, text font, text color, textual information, etc.), visual presentation of the application (e.g., contrast ratio, resolution, etc.), and/or a data transmission or delivery parameter of the application (e.g., bandwidth, encoding rate, requested resolution, etc.).

Knowledge of ambient illuminance may aid in the rendering of visual information on a display of a device. For example, the mobile devices may be equipped with a dedicated ambient illuminance sensor. The sensor may provide information that may be inaccurate. For example the readings provided by the sensor may be off by an order of magnitude. In some devices, such sensors may be absent. Alternative ways of estimating or calculating ambient illuminance may be provided. Implementations described herein may be applied to the rendering of video on a personal computer (PC) or other types of devices that may not have an ambient light sensor included.

There may be a relationship between camera settings parameters that may be related to ISO speed and subject illuminance. The relationship may be given by an incident-light exposure equation, such as:

$$\frac{{N}^{2}}{t} = \frac{ES}{C} \qquad Equation 1$$

where E may be illuminance (e.g., in lux), N may be relative aperture (e.g., f-number), t may be exposure time (e.g., shutter speed) in seconds, S may be ISO arithmetic speed, and C may be incident-light meter calibration constant.

Equation 1 may be rewritten with regards to illuminance E. For example, Equation 1 may be rewritten as:

$$E = C \frac{ {N}^{2}}{t S} \qquad Equation 2$$

Equation 2 may be used by extracting values of one or more camera settings/parameters of a camera of a mobile device. The camera setting may include, for example, illuminance, relative aperture, exposure time, ISO arithmetic speed, incident-light meter calibration constant, etc. The camera setting may be recorded for a captured image in a JPEG's EXIF file headers. The camera setting may be obtained via an application programming interface (API) of the camera. The camera setting may be used with Equation 2 to compute illuminance. A proper value of the calibration constant C may be determined to ensure accurate results.

One or more values for the incident-light calibration constant may be used. For example, ISO 2720:1974 may discuss design of photographic exposure meters and may suggest setting C in the range of 240 to 400 when a flat light receptor is used. In case of a hemispherical receptor, ISO 2720:1974 may suggest a range for C of 320 to 540. An ideal suitable value of C may be determined on a device-specific basis.

Implementations relating to the selection of the calibration constant C may be described herein. For example, Table 1 provides an example of measurements that may be obtained by using a front camera of a mobile device (e.g., a smartphone) and by using a light meter (e.g., a SpectraCine Candella-II ambient light meter). Pictures may be taken and saved as JPEG images by an application residing on the mobile device (e.g., a native camera application). The camera setting values may be obtained from the saved JPEG images. For example, the camera parameters may be retrieved from an EXIF header in a JPEG file. The camera setting values may be obtained from an API of the camera, and therefore, pictures may not have to be taken and/or saved by an application residing on the mobile device.

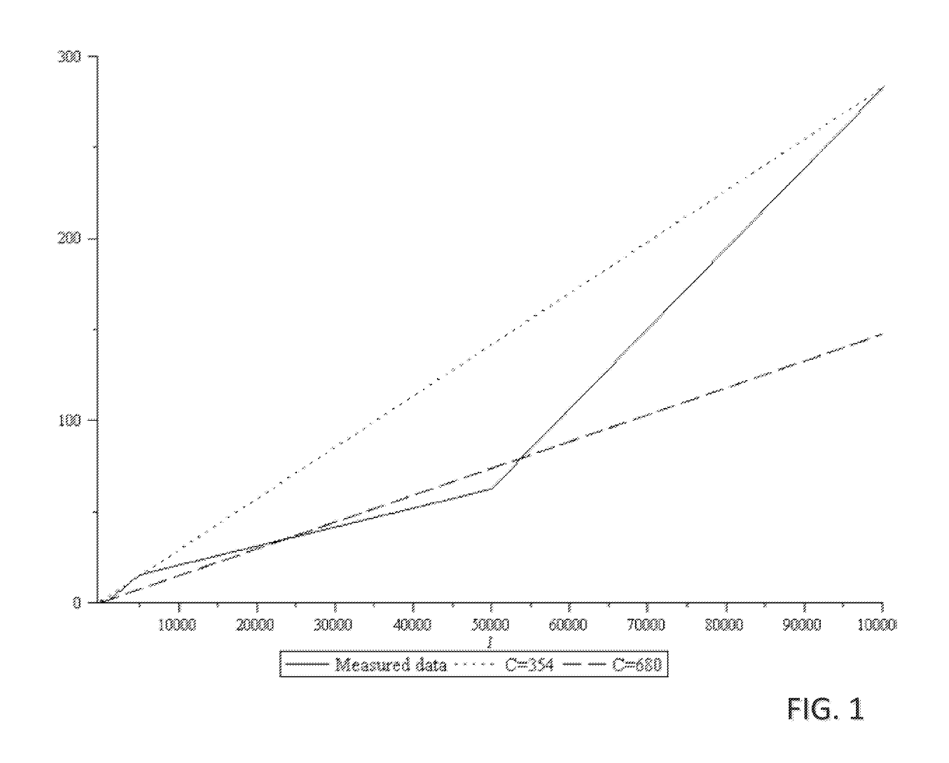

In determination of the calibration constant C, if the measurement corresponding to direct sunlight exposure is included, the resulting calibration constant C may equal to 354.5. If the first measurement corresponding to direct sunlight exposure is excluded, the rest of points may be well modeled using a calibration constant C that may equal 680. FIG. 1 is a graph illustrating an example modeling of the calibration constant C. As illustrated in FIG. 1, the first measurement corresponding to direct sunlight exposure may be problematic, for example, as it may reach the limit of dynamic range of our reference device (e.g., SpectraCine Candella-II). Such a situation as captured by the first measurement, viewing a display in direct sunlight exposure, may represent a situation where viewing a display is difficult regardless of the display parameters. Estimates using an example model that may be obtained by excluding the first measurement may be provided, for example, as exemplified in Table 1.

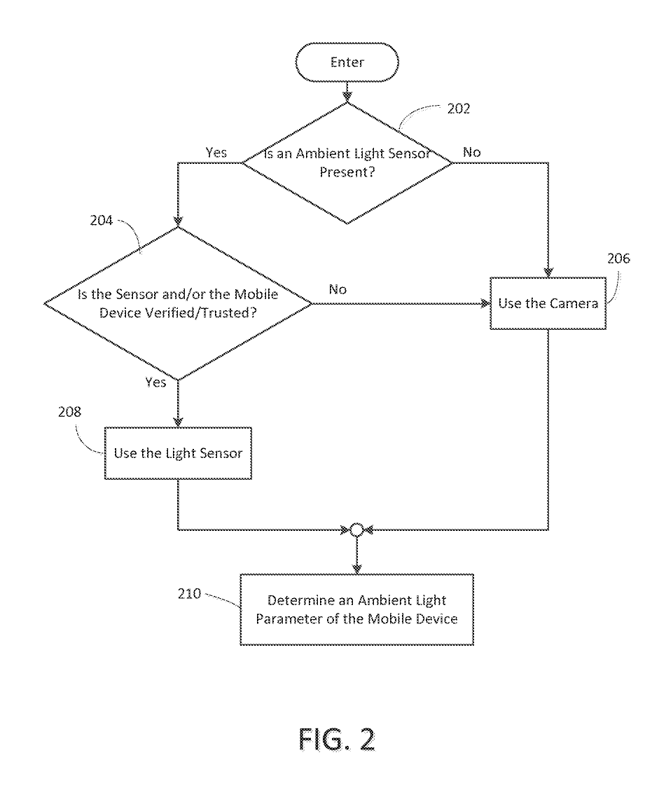

FIG. 2 is a diagram illustrating an example of computing ambient illuminance. As illustrated in FIG. 2, at 202 a determination may be made whether or not the mobile device includes an ambient light sensor. If the mobile device includes an ambient light sensor, at 204, a determination may be made whether or not the sensor and/or the mobile device is trusted/verified. As described herein, some ambient light sensors may be inaccurate to properly determine an ambient light parameter (e.g., illuminance). The sensors and/or mobile devices that can accurately determine the ambient light parameter may be deemed trusted or verified. The verification may be preconfigured by the mobile device or an application residing on the mobile device, or the verification may be determined an as-needed basis by an application residing on the mobile device. If the mobile device does not include an ambient light sensor and/or the sensor and/or the mobile device is not trusted or verified, at 206, and 210, a camera may be used to determine an ambient light parameter (e.g., illuminance) of the mobile device. If the sensor or mobile device is trusted or verified, at 208, and 210, the ambient light sensor may be used to determine an ambient light parameter (e.g. illuminance) of the mobile device.

The ambient light parameter (e.g., illuminance) may be used by an application of the mobile device to enhance a user's experience and/or increase performance of the mobile device. For example, a user interface (UI) parameter, a delivery parameter, and/or a visual information parameter of an application residing on the mobile device may be changed in response to the ambient light parameter. For example, the UI parameter may be the text size, the text font, the text color, the textual information, or user input of the application that may be displayed to a user. By altering a UI parameter using the ambient light parameter, the user may better view and interact with the application since the text or user input may be altered for the specific illuminance experienced by the mobile device. The delivery parameter may be, for example, the bandwidth required/allocated to the application/mobile device for the reception of content (e.g., from a network), the encoding rate of content (e.g., which may be received from a network), or the requested resolution of content (e.g., which may be received from the network). A mobile device may utilize bandwidth (e.g., more efficiently utilize bandwidth), save battery power, and/or reduce processing power by tailoring the content being displayed on a display of the mobile device for the specific lighting conditions being experienced, e.g., by altering a delivery parameter of the application using the ambient light parameter. The visual information parameter may be, for example, the contrast ratio or the resolution of a still image or video of the application. The user may view a still image or video of the application on the display of the mobile device in the specific lighting conditions being experienced, e.g., by altering a visual information parameter of the application.

Implementations relating to a framework and an application programming interface (API) for using one or more inputs from a front camera and/or sensors in a mobile device to detect, for example, a user's presence and estimate his/her distance from the screen may be provided. Implementations described herein may offer a framework and an API (e.g., a top-level API) for a library/module that combine inputs from a plurality of sensors in a mobile device and reports a user's presence and his/her distance to the screen to an application. The plurality of sensors may capture complementary information that may be used to infer the presence of the user and his/her likely distance from the mobile device.

User detection and estimation of a user's distance to the screen may be provided. For example, user detection and a user's distance to the screen may be provided to be used in adaptive streaming applications to reduce video rate and/or bandwidth usage. User detection and a user's distance to the screen may be provided to be used in video conferencing applications, e.g., to optimize the communication system user interface (UI) and/or behavior. User detection and a user's face distance from a screen may be useful in 3D gaming or streaming applications to improve renderings of 3D objects and/or videos (e.g., based on a user's relative position and/or direction of view). User face detection and a user's distance from the screen may be useful in web-browsing and text editing applications to adjust (e.g., dynamically adjust) the scale of fonts and page display to make it more convenient for a user to read them. User detection and a user's distance to the screen may be useful in future display hardware to reduce (e.g., dynamically reduce) the resolution or other rendering parameters that may result in energy savings and/or improved accuracy of video delivery to the user. User detection and a user's distance to the screen may be useful in general UI functions and controls (e.g., icons, etc.) which may be adjusted based on a user's distance and related limits of his/her vision and/or precision of motion control.

A user's distance may be a parameter that may affect other functions and applications. Implementations described herein may define a framework and API for user detection that may be useful for a plurality of applications that need information about the user in order to optimize their behavior.

Implementations described herein may relate to user detection and user distance estimation in mobile devices. For example, implementations described herein may address false alarms and misdetection in face detection. Face detection algorithms (e.g., those supplied with mobile operating systems) may detect background as a user's face, which may be a false alarm and may result in an inaccurate estimate of face distance. Misdetection may occur when the user holds the phone too close to his/her face, for example, when the camera cannot capture the whole face for face detection.

Implementations described herein may address user activity detection. Applications may require that a user's activity is detected in place of face detection. For example, one or more of the following user activities may be distinguished: user is holding the phone in hand, user put the phone in a pocket, user put the phone on the table (or any other fixed/stationary location), etc. If different activities of a user can be detected and/or distinguished, user activity adaptive applications may be designed (e.g., in accordance with implementations described herein).

When a mobile device is held in hand, it may be held while the user is in a static position (e.g., sitting or standing), while the user is in motion (e.g., walking or in a moving vehicle), in the user's lap (e.g., sitting in a living room watching a movie in a tablet), or other states. Such differentiation may be helpful because viewing distance (i.e., user's face distance) and other conditions (e.g., visual fixation) may affect how video is perceived in these different states. It may be possible to differentiate between states (e.g., by using sensors in a mobile device) and, design user activity adaptive applications. For example, in a mobile device, accelerometer(s) and gyroscope(s) may be used to determine that a user is in a static position (e.g., low variance in sensor readings), a user is in motion (e.g., high variance in sensor readings), a device is in the user's lap (e.g., sensor readings show low frequency muscular tremor). These states (e.g., motion states) may be associated with typical viewing distances. For an identified state, a streaming bit rate, e.g., in a multimedia application, may be adapted according to the identified state.

Implementations described herein may address sensor and camera framework and API. Sensors (e.g., camera and/or face detection) may be used for video streaming (e.g., viewing condition adaptive streaming). Sensors may be used for other applications, for example, user adaptive video encoding, user adaptive web browser, etc. Different applications may require different functionalities. The applications may be user adaptive. Implementations described herein may provide for user detection (e.g., face detection, user presence, etc.)

Implementations described herein may address sensor signal processing. To extract useful information from the data collected by mobile sensors, implementations may include signal processing, for example, to design a filter and collect statistics for the sensor data. The data collected by the sensors may be non-uniform, irregular, and/or random. Implementations may not apply a filter directly to the data collected.

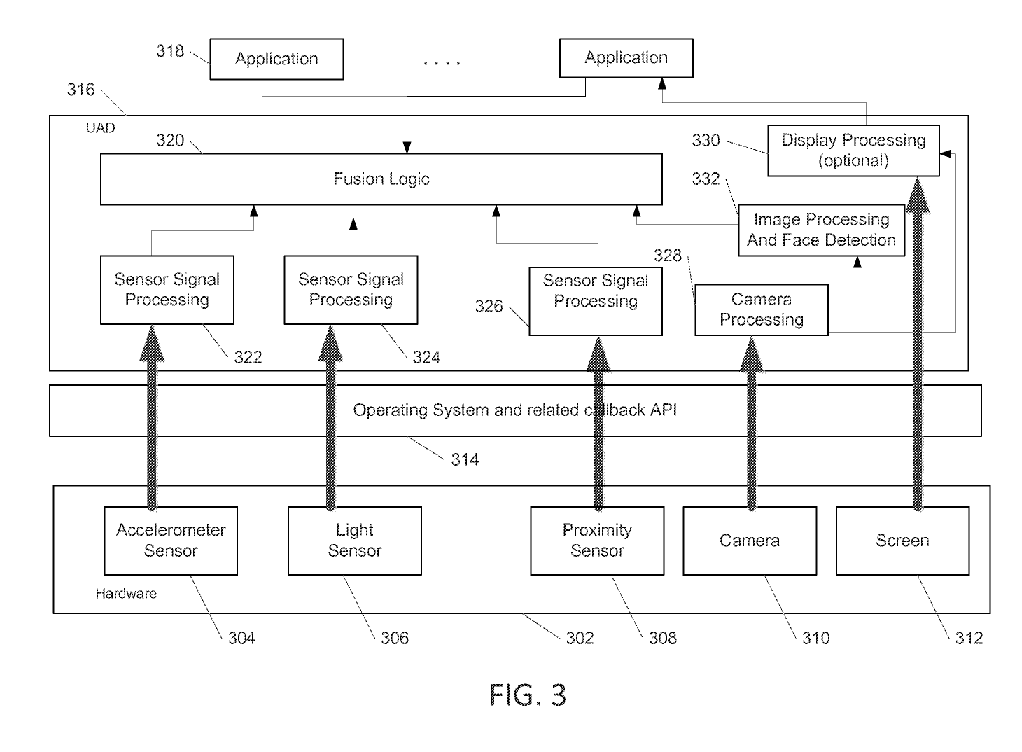

Sensor and camera framework and API may be provided. FIG. 3 is a diagram illustrating an example of a user activity detection (UAD) API and framework architecture. As illustrated in FIG. 3, an application 318 may be configured to utilize the UAD API. As illustrated in FIG. 3, the UAD 316 may be provided. The UAD 316 may be built on top of the OS run on a mobile device. The OS may provide accessibility to different hardware devices 302 and/or sensors in a mobile device, for example, sensors, camera 310, screen orientation, GPS, etc. The UAD 316 framework may capture data/input from one or more sensors in a mobile device, for example, a camera 310, a microphone, a light sensor 306, a global positioning system (GPS), an accelerometer 304, a gyroscope, a proximity sensor 308, a compass, a pedometer, a touch screen 312, a skin conductivity sensor, a pressure meter/sensor (e.g., a sensor that measures the user's grip on the phone), a light sensor 306, etc. The UAD framework may process the data/input from the one or more sensors. The UAD framework may present the results to applications though a dedicated UAD API.

The UAD 316 may include one or more of the following: display processing 330, camera processing 328, image processing and face detection 332, sensor signal processing 322, 324, and 326, and fusion logic 320. The architecture may be extended. An operating system (e.g., Android Operating system) 314 may be provided. Android operating system may be used as an exemplary OS in the description of implementations herein, but basic principles may be applied for other operating systems.

Display processing 330 of the UAD 316 may be provided. With some applications, the user may not want to know what happen behind the UAD. For example, the user may be watching streaming video and may not want to be distracted with other information. The application may show (e.g., only show) the content provided by the application and not input from the UAD (e.g., a camera image). With some applications, the user may want to see the content from UAD block. For example, in a debug mode or in some interactive applications, the user may want to see the face detection result from the screen display. The UAD 316 may provide an option for the user to select whether to display the UAD result or not.

The display processing may setup a thread to read a bitmap file from the camera processing and face detection blocks and display it on the screen (e.g., periodically). The display processing and/or display of face may be performed if displaying a UAD result is desired. This maybe done internally and transparent to the user.

Camera processing may be provided. Implementations (e.g., on Android OS) to acquire the image captured by the camera may include user initiate capture, which may include a camera intent method and Camera.takePicture( ) method, and preview callback capture, which may be set by different callback functions (e.g., setPreviewCallback, setPreviewCallbackWithBuffer, and setOneShotPreviewCallback). A face detector may receive an image (e.g., continuously receive image(s)) from a camera. A callback method may be utilized. If a user does not want to show the preview on screen while using callback (e.g., in Android OS with API level 10 and before), it may be performed by setting null to the display SurfaceHolder in the OS (e.g., in Android set setPreviewDisplay (null)). A user may provide an OS with a SurfaceHolder to setPreviewDisplay function, otherwise, the callback may not work (e.g., in Android OS with API level 11). The OS (e.g., Android) may add an API function (e.g., an API function called setPreviewTexture for API level 11 and after). This may be used for CPU processing and rendering of camera image. The API may be used for the camera callback in the framework described herein.

The camera processing block may interact with the display processing block. The camera may know the orientation of the display and provide the parameters (e.g., before calculating face distance). The camera processing block may share a bmp buffer with the display processing block.

The camera processing may setup a thread to pull raw image data from the camera callback API and do image processing and face detection (e.g., periodically). This may be performed internally and transparent to the user.

Image processing and face detection may be provided. Image processing may be added before face detection. The framework may allow the addition of one or more image preprocessing techniques operating on raw image data. For example, the framework may utilize camera image denoising, downsampling/upsampling, temporal image filtering, etc. For example, a YUV image may be converted to a bmp image, which may be provided, for example, as color image output and/or gray image output.

If the OS provides a native API for face detection, the implementations described herein may utilize the native API for face detection. For example, Android OS may provide such functionality. Implementations may run a software implementation (e.g., a software implementation of the Viola-Jones algorithm).

Face distance estimation (e.g., using face detector results) may be provided. If a result of a face detector is positive, the results may be utilized to estimate the distance of the user to the screen of a mobile device. An eye position detector may be utilized to determine the user's interpupilary distance (IPD) to derive the user's distance from the screen. The user's IPD value may utilized as one of the parameters that a user may specify. A default IPD value may be set. For example, a default IPD may be set to 63 mm, which may correspond to an average value for adult viewers. The standard deviation of IPD distribution among adult viewers may be approximately 3.8 mm. For a majority of viewers, their true IPD may differ from 63 mm up to 18%.

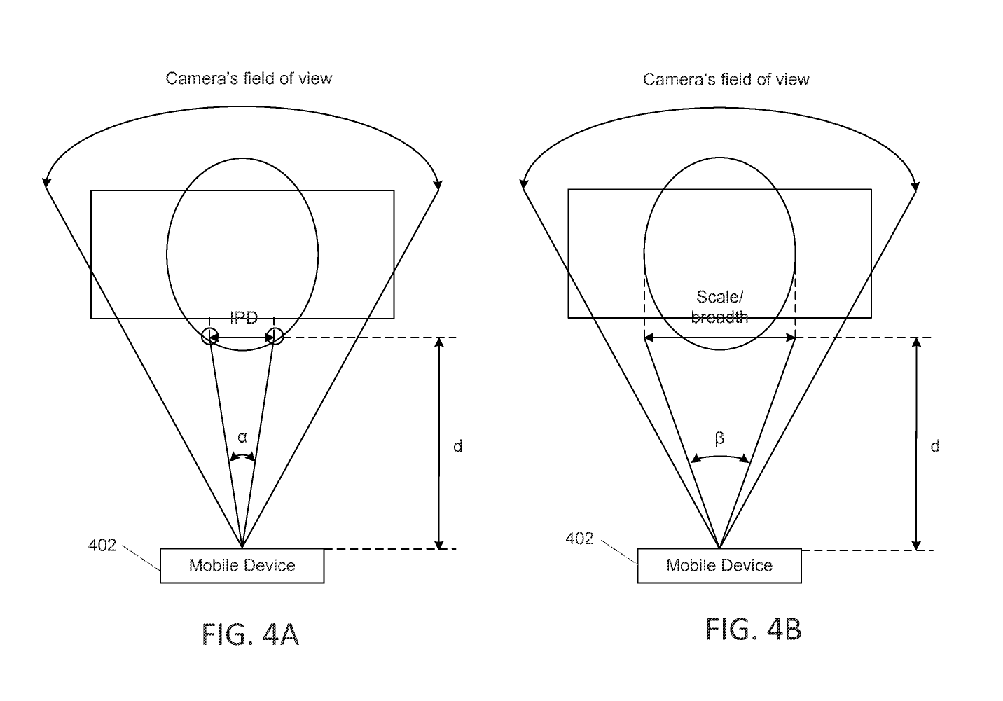

A face breadth/scale parameter may be returned by the face detection algorithm, if eye detection is not available or does not produce positive results, implementations may utilize. FIG. 4A is a diagram illustrating an example computation of a user's face distance from a screen using interpuppilary distance (IDP). FIG. 4B is a diagram illustrating an example computation of a user's distance from a screen using head scale/breadth (e.g., as may be reported by a face detector). Camera view angle and the angle between user's eyes (α) or angle capturing head breadth (β) may be utilized. The camera view angle may depend on the orientation of the mobile device 402. Values may be retrieved after reading input(s) from an orientation sensor to ensure that the camera view angle is corrected determined.

Implementations to compute a user's distance to the screen using the angle between user's eyes (α) may be provided. The derivations using head breadth angle (β) may be similar. The distance d a user's is from the screen may be determined using:

$$tan ( \text{∝} / 2 ) = \frac{I P D}{2 d} ,$$

which may be rewritten as:

$$d = I P D \frac{1}{2 tan ( \text{∝} / 2 )} .$$

We may then utilize:

$$\frac{I P D [ pixels ]}{tan ( \text{∝} / 2 )} = \frac{camera image width}{tan ( camera field of view [ ° ] / 2 )} ,$$

which may provide:

$$tan ( \text{∝} / 2 ) = tan ( camera field of view [ ° ] / 2 ) \frac{I P D [ pixels ]}{camera image width} ,$$

These equations may be utilized to determine the user's distance d from the screen of a mobile device.

Sensor signal processing may be provided. An OS may support a plurality of sensors. For example, the a version of Android OS may support 13 different sensors. Phones may include a subset of those sensors available. Signal processing of sensor data may be included as part of the UAD. Different user activities may result in different sensor data statistics. For example, people may hold the mobile device in their hand, put the mobile device in their pocket, and/or put the mobile device on the top of a table, each condition may result in different sensor data statistics.

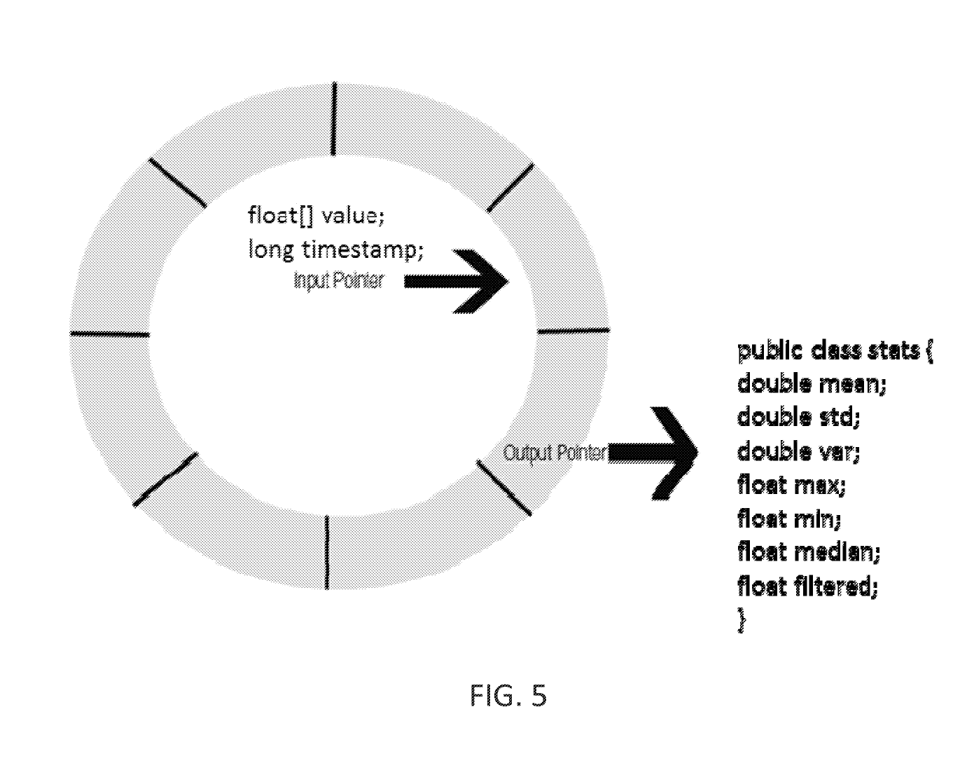

FIG. 5 is a diagram illustrating an example of a data structure for sensor signal processing. Signal processing (e.g., filtering) may benefit from uniform signal sampling. In some OSs (e.g., Android), the sampling data from sensors may be non-uniform. A circular buffer may be designed and utilized where each element may have a plurality of components. For example, each element may have two components, a sample value and a time stamp, as shown in FIG. 5. Sensor samples may be placed into a circular buffer (e.g., randomly), but the statistics may be regularly retrieved by fusion logic. The time stamp may be used for refining statistics. The time stamp may be used for weighted filter design. Sensor signal processing blocks may share the similar structure and therefore, a common part may be implemented as a class with a flexible API.

Fusion logic may be provided. Fusion logic may combine inputs from one or more (e.g., a plurality) of sensors, for example, to produce UAD metrics exposed to an application by an API. Implementations described herein may collect and compute statistics and other useful information from different sensor signal processing blocks, image processing and face detection blocks, etc. Implementations described herein may analyze and process the statistics based on a requirement(s) of an application(s). Implementations described herein may produce results for application design. One example of fusion logic may be to detect whether a user is in presence of the screen and to improve the face detection result, for example, as described herein.

A UAD API may be provided. Elements of the top-level user activity API may be provided herein. For example, in order to start a UAD library, the application may instantiate a class UserActivityDetection. This may be done my means of the following call:

mUAD=new UserActivityDetection(this, display_flag);

where display_flag may indicate if the front camera preview window may be projected to the screen.

This function may be called, for example from the onCreate( ) callback function in the application. If showing a preview window is desired, an application may call:

if (display_flag) {

setContentView(mUAD.get_display( ));

}

In order to stop the display, an application may call:

mUAD.mDisplay.stop_display( );

An application may add one or more of the following calls in the activity callbacks:

public void onDestroy( ) {

super.onDestroy( );
mUAD.destroy( );

}
@Override
protected void onResume( ) {

super.onResume( );
mUAD.resume( ):

}
@Override
protected void onPause( ) {

super.onPause( );
mUAD.pause( );

}

In order to retrieve a user activity result(s), an application pray use the following interface:

m_uad_result=mUAD.get_uad_result_{—}1( );

where m_uad_result is currently defined as the following structure:

public class uad_result_1 {

public boolean user_detected;
public float face_distance;

}

User activity detection may be provided, for example, when a user holds a mobile device (e.g., phone/tablet) in their hand(s), when a user is carrying the mobile device in a pocket/sleeve, and/or when a user is not holding or carrying the mobile device (e.g., if the mobile device is on top of the table).

When a user is watching a video or any other content on their mobile device, the phone may be in the user's hand. Implementations for detecting a user's presence may be based on a plurality of criteria. For example, implementations for detecting a user's presence may be based on statics of acceleration (e.g., in all three directions) and the direction of gravity relative to the orientation of the mobile device.

If the data produced by an accelerometer (e.g., a variance of the data) exceeds a certain value threshold, it may be determined that a user is present. The phone's orientation may be used to improve detection, e.g., by lowering the threshold. For example, when a user watches video on their mobile device, the user may hold the mobile device in a certain range of angles. This range of angles may be utilized to by the implementations described herein. The phone's orientation (e.g., via the range of angles) may be utilized in scenarios when a user watches video on their mobile device.

The fusion (e.g., combination) of data received from a plurality of sensors may be utilized to reduce false alarms in face detection and face proximity detection. For example, OpenCV may implement the Viola-Jones face detection algorithm, e.g., as an open source implementation based on the Viola-Jones face detection algorithm. Features may be used or added to improve the face detection (e.g., by reducing false alarm and misdetection rate), for example, by using a geometric face feature, a temporal motion limitation, post-image processing techniques, etc. A native face detection algorithm may be utilized, e.g., to supplement the Viola-Jones face detection algorithm (e.g., in the Android OS). Additional sensors in the phone may be utilized to improve the face detection result. For example, the native face detection algorithm in Android may detect some background as a user's face, which may be a false alarm and result in a wrong estimate of face distance. Another scenario for misdetection may be when the user holds the mobile device too close to his/her face, where the camera may not be able to capture the whole face for face detection.

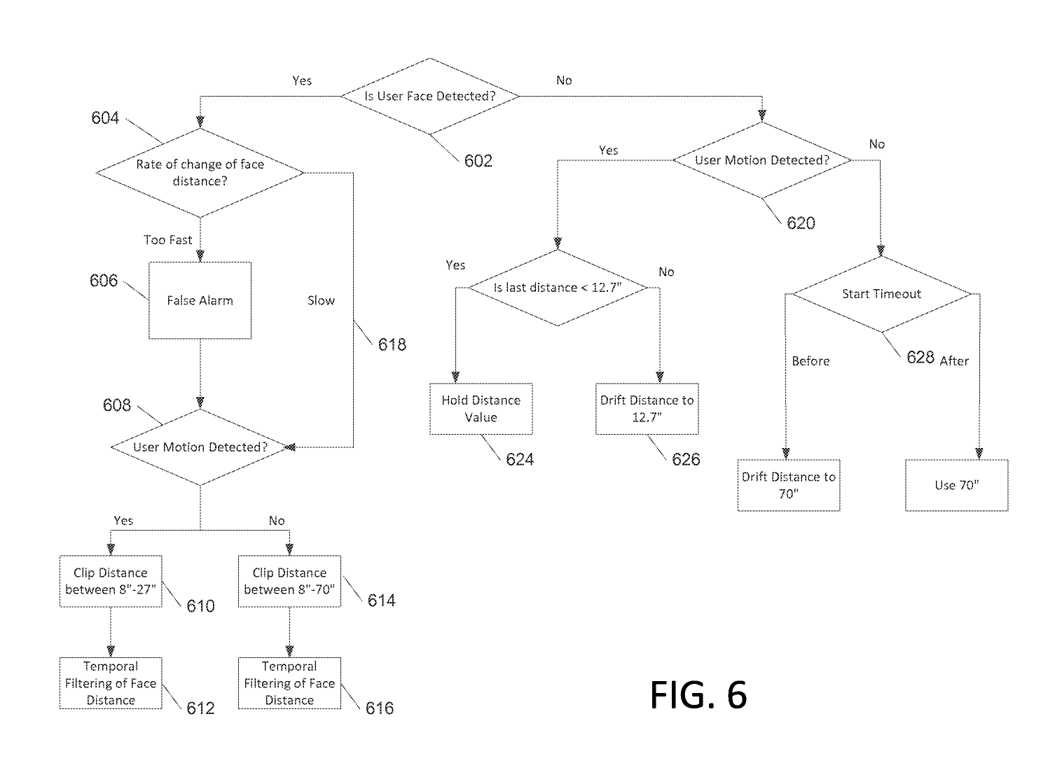

FIG. 6 is illustrates an example of face detection and face proximity determinations, e.g., which may use fusion techniques described herein. At 602, a face detection algorithm may be called. If a face is detected, the distance between the device and the user face may be calculated, for example, by the image plane detector (ipd) and/or camera viewing angle range, e.g., as described herein. Along with the face distance, at 604 the rate of change of face distance may be computed. The rate of change of face distance may be performed to check for the consistency of the detected face. For example, if the face distance rate of change is high, at 606 it may be determined that the detected face was a false positive, and the information from a plurality of the device sensors may be used to determine user presence.

Accelerometer statistics may be used to determine whether the user is holding the device or not (e.g., motion status indicates device is in motion or not). At 608 user motion may be detected (e.g., motion status indicates device is in motion). If the user's motion is detected (e.g., motion status indicates device is in motion), at 610 the distance between the user's face and the screen may be capped to a range (e.g., 8-27 inches range may be used along with detected motion to confirm user presence, so, if motion is detected and a face is detected within the 8-27 inch range a user's presence may be confirmed). The 8-27 inches range may be a range normally achievable when a user is holding their mobile device. If the accelerometer data indicates that the device is at rest (e.g., motion status indicates device is at rest), at 614 it may be assumed that the user is not holding the device and at 614, the upper limit of the range may be relaxed and set to another range (e.g., 8-70 inches range may be used to confirm user presence, so, if no motion is detected and a face is detected within the 8-70 inch range a user's presence may be confirmed). The 8-70 inches range may correspond to a typical operation range of a face detector algorithm. If the user is farther from the screen, the resolution of the camera and the precision of the face detector may not be enough to detect the user's presence.

When processing face detection results, other factors, e.g., velocity of human motion (e.g., finite velocity of human motion) may be considered. For example, it may be assumed that if person is holding the phone, the viewing distance may change slowly, and jumps exceeding a specific range (e.g., 3-5 inches/sec) may be used as indicators of false alarms.

At 612 or 616, the face distance values obtained may be filtered temporally, for example, using a low pass filter or a median filter. The filtered result may be sent to a user application, which may call UAD API.

In situations where the face detection algorithm does not detect a face, the implementations described herein may depend on the sensors statistics and/or previously detected face distance. At 620, if the sensor data indicates the user's presence and the face distance value is less than a threshold (e.g., 12.7 inches), which may be the mean distance for user activity, at 624 the detected value of face distance may be held. This is because, if a face was not detected but user presence was detected and the user was close to the device earlier, there may be a high chance that the user may still be close to the device but the camera may not be able to capture the whole face for face detection. In situations where the computed face distance value was greater than the threshold (e.g., 12.7 inches), at 626 the computer face distance may be drifted (e.g., gradually drifted) to the threshold (e.g., 12.7 inches).

In situations wherein the user's face was not detected and no user presence was detected, at 628 a timeout may be started and the face distance value may drift (e.g., gradually drift) towards a threshold (e.g., 70 inches). This threshold may limit the horizon at which a user may be sensed, e.g., when the user may use a frontal camera.

The use of drift (e.g., gradual drift) in both cases may add an extra degree of robustness to the algorithm. For example, the user may be briefly in/out of camera's view field, and if he/she appears again in a short period of time, then the drift may cause only small fluctuations in the reported distances.

The details disclosed herein are intended to be exemplary and in no way limit the scope of the application. Additional implementations may be used or added with the disclosed subject matter. For example, an ambient illuminance sensor may be utilized, for example, in combination with a camera input to determine if the camera and/or illuminance sensors are blocked (e.g., by user holding the phone). The orientation of the phone may also be utilized, for example, to determine if the face detector may be operational, etc. Inputs from other sensors, such as but not limited to display touch, proximity, and microphone sensors may be factored (e.g., combined) into the fusion logic to improve the reliability of the results.

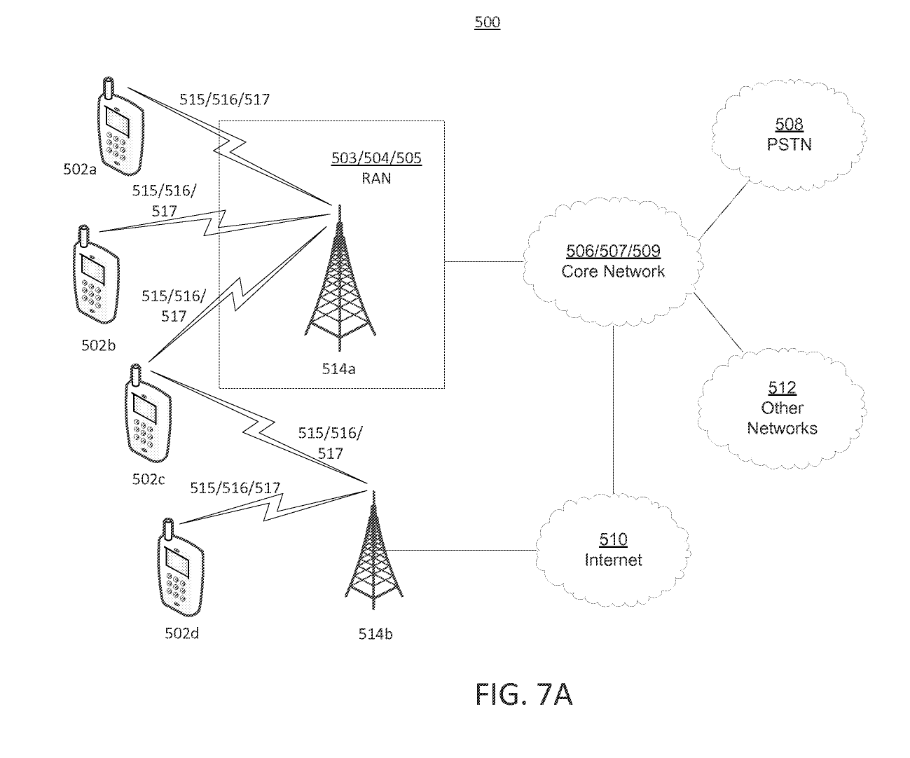

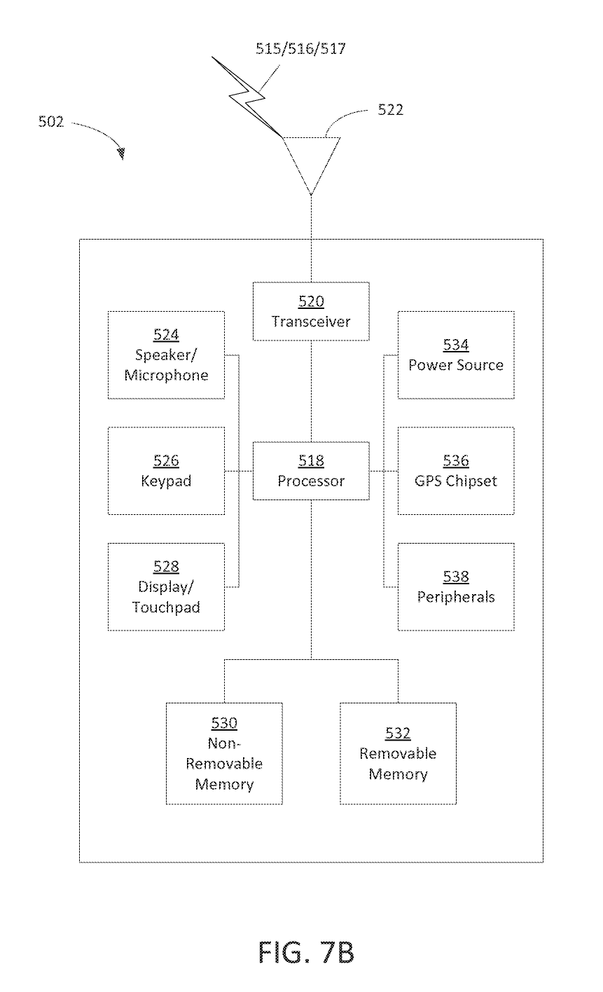

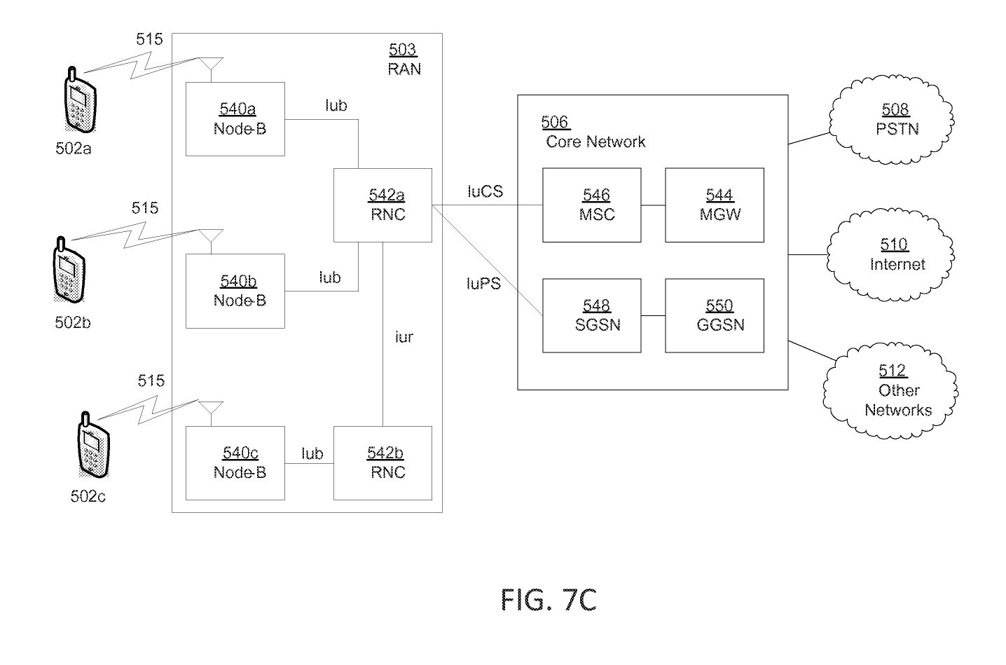

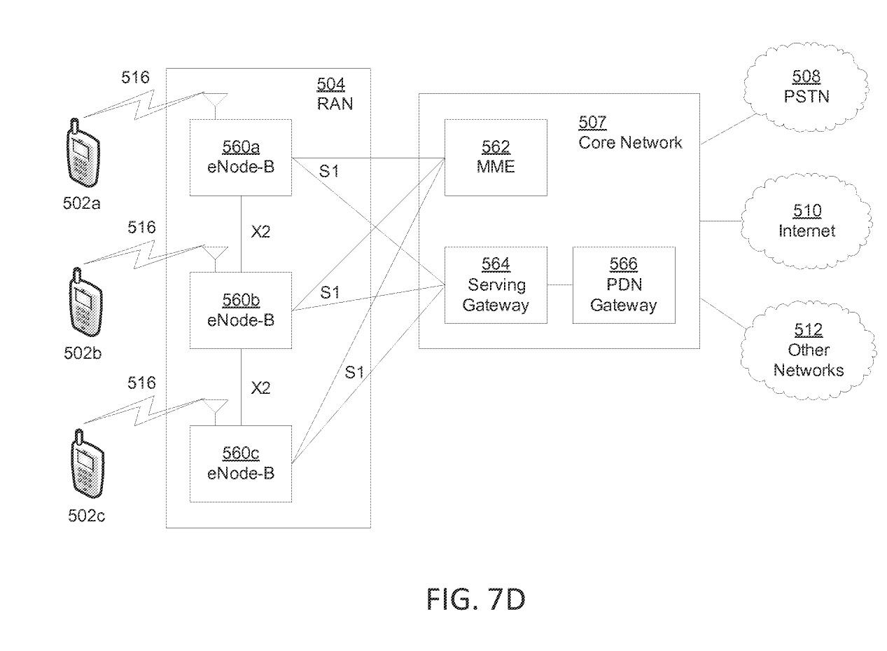

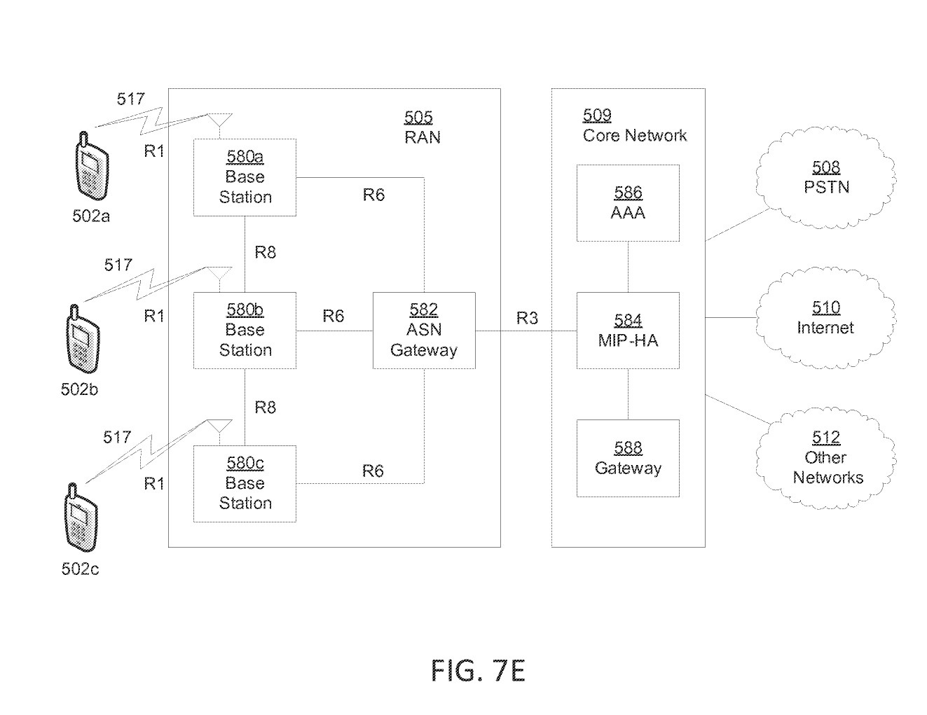

FIG. 7A is a diagram of an example communications system 500 in which one or more disclosed embodiments may be implemented. The communications system 500 may be a multiple access system that provides content, such as voice, data, video, messaging, broadcast, etc., to multiple wireless users. The communications system 500 may enable multiple wireless users to access such content through the sharing of system resources, including wireless bandwidth. For example, the communications systems 500 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 7A, the communications system 500 may include wireless transmit/receive units (WTRUs) 502a, 502b, 502c. 502d, a radio access network (RAN) 503/504/505, a core network 506/507/509, a public switched telephone network (PSTN) 508, the Internet 510, and other networks 512, though it will be appreciated that the disclosed embodiments contemplate any number of WTRUs, base stations, networks, and/or network elements. Each of the WTRUs 502a, 502b, 502c, 502d may be any type of device configured to operate and/or communicate in a wireless environment. By way of example, the WTRUs 502a, 502b, 502c, 502d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, or any other terminal capable of receiving and processing compressed video communications.

The communications systems 500 may also include a base station 514a and a base station 514b. Each of the base stations 514a, 514b may be any type of device configured to wirelessly interface with at least one of the WTRUs 502a, 502b, 502c, 502d to facilitate access to one or more communication networks, such as the core network 506/507/509, the Internet 510, and/or the networks 512. By way of example, the base stations 514a, 514b may be a base transceiver station (BTS), a Node-B, an eNode B, a Home Node B, a Home eNode B, a site controller, an access point (AP), a wireless router, and the like. While the base stations 514a, 514b are each depicted as a single element, it will be appreciated that the base stations 514a, 514b may include any number of interconnected base stations and/or network elements.

The base station 514a may be part of the RAN 503/504/505, which may also include other base stations and/or network elements (not shown), such as a base station controller (BSC), a radio network controller (RNC), relay nodes, etc. The base station 514a and/or the base station 514b may be configured to transmit and/or receive wireless signals within a particular geographic region, which may be referred to as a cell (not shown). The cell may further be divided into cell sectors. For example, the cell associated with the base station 514a may be divided into three sectors. Thus, in one embodiment, the base station 514a may include three transceivers, i.e., one for each sector of the cell. In another embodiment, the base station 514a may employ multiple-input multiple output (MIMO) technology and, therefore, may utilize multiple transceivers for each sector of the cell.

The base stations 514a, 514b may communicate with one or more of the WTRUs 502a, 502b, 502c, 502d over an air interface 515/516/517, which may be any suitable wireless communication link (e.g., radio frequency (RF), microwave, infrared (IR), ultraviolet (UV), visible light, etc.). The air interface 515/516/517 may be established using any suitable radio access technology (RAT).

More specifically, as noted above, the communications system 500 may be a multiple access system and may employ one or more channel access schemes, such as CDMA, TDMA, FDMA, OFDMA, SC-FDMA, and the like. For example, the base station 514a in the RAN 503/504/505 and the WTRUs 502a, 502b, 502c may implement a radio technology such as Universal Mobile Telecommunications System (UMTS) Terrestrial Radio Access (UTRA), which may establish the air interface 515/516/517 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 514a and the WTRUs 502a, 502b, 502c may implement a radio technology such as Evolved UMTS Terrestrial Radio Access (E-UTRA), which may establish the air interface 515/516/517 using Long Term Evolution (LTE) and/or LTE-Advanced (LTE-A).

In other embodiments, the base station 514a and the WTRUs 502a, 502b, 502c may implement radio technologies such as IEEE 802.16 (i.e., Worldwide interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 514b in FIG. 7A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 514b and the WTRUs 502c, 502d may implement a radio technology such as IEEE 802.11 to establish a wireless local area network (WLAN). In another embodiment, the base station 514b and the WTRUs 502c, 502d may implement a radio technology such as IEEE 802.15 to establish a wireless personal area network (WPAN). In yet another embodiment, the base station 514b and the WTRUs 502c, 502d may utilize a cellular-based RAT (e.g., WCDMA, CDMA2000, GSM, LTE, LTE-A, etc.) to establish a picocell or femtocell. As shown in FIG. 7A, the base station 514b may have a direct connection to the Internet 510. Thus, the base station 514b may not be required to access the Internet 510 via the core network 506/507/509.

The RAN 503/504/505 may be in communication with the core network 506, which may be any type of network configured to provide voice, data, applications, and/or voice over internet protocol (VoIP) services to one or more of the WTRUs 502a, 502b, 502c, 502d. For example, the core network 506/507/509 may provide call control, billing services, mobile location-based services, pre-paid calling, Internet connectivity, video distribution, etc., and/or perform high-level security functions, such as user authentication. Although not shown in FIG. 7A, it will be appreciated that the RAN 503/504/505 and/or the core network 506/507/509 may be in direct or indirect communication with other RANs that employ the same RAT as the RAN 503/504/505 or a different RAT. For example, in addition to being connected to the RAN 503/504/505, which may be utilizing an E-UTRA radio technology, the core network 506/507/509 may also be in communication with another RAN (not shown) employing a GSM radio technology.

The core network 506/507/509 may also serve as a gateway for the WTRUs 502a, 502b, 502c, 502d to access the PSTN 508, the Internet 510, and/or other networks 512. The PSTN 508 may include circuit-switched telephone networks that provide plain old telephone service (POTS). The Internet 510 may include a global system of interconnected computer networks and devices that use common communication protocols, such as the transmission control protocol (TCP), user datagram protocol (UDP) and the internet protocol (IP) in the TCP/IP internet protocol suite. The networks 512 may include wired or wireless communications networks owned and/or operated by other service providers. For example, the networks 512 may include another core network connected to one or more RANs, which may employ the same RAT as the RAN 503/504/505 or a different RAT.

Some or all of the WTRUs 502a, 502b, 502c, 502d in the communications system 500 may include multi-mode capabilities, i.e., the WTRUs 502a, 502b, 502c, 502d may include multiple transceivers for communicating with different wireless networks over different wireless links. For example, the WTRU 502c shown in FIG. 7A may be configured to communicate with the base station 514a, which may employ a cellular-based radio technology, and with the base station 514b, which may employ an IEEE 802 radio technology.

FIG. 7B is a system diagram of an example WTRU 502. As shown in FIG. 7B, the WTRU 502 may include a processor 518, a transceiver 520, a transmit/receive element 522, a speaker/microphone 524, a keypad 526, a display/touchpad 528, non-removable memory 530, removable memory 532, a power source 534, a global positioning system (GPS) chipset 536, and other peripherals 538. It will be appreciated that the WTRU 502 may include any sub-combination of the foregoing elements while remaining consistent with an embodiment. Also, embodiments contemplate that the base stations 514a and 514b, and/or the nodes that base stations 514a and 514b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 7B and described herein.

The processor 518 may be a general purpose processor, a special purpose processor, a conventional processor, a digital signal processor (DSP), a graphics processing unit (GPU), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 518 may perform signal coding, data processing, power control, input/output processing, and/or any other functionality that enables the WTRU 502 to operate in a wireless environment. The processor 518 may be coupled to the transceiver 520, which may be coupled to the transmit/receive element 522. While FIG. 7B depicts the processor 518 and the transceiver 520 as separate components, it will be appreciated that the processor 518 and the transceiver 520 may be integrated together in an electronic package or chip.

The transmit/receive element 522 may be configured to transmit signals to, or receive signals from, a base station (e.g., the base station 514a) over the air interface 515/516/517. For example, in one embodiment, the transmit/receive element 522 may be an antenna configured to transmit and/or receive RF signals. In another embodiment, the transmit/receive element 522 may be an emitter/detector configured to transmit and/or receive IR, UV, or visible light signals, for example. In yet another embodiment, the transmit/receive element 522 may be configured to transmit and receive both RF and light signals. It will be appreciated that the transmit/receive element 522 may be configured to transmit and/or receive any combination of wireless signals.

In addition, although the transmit/receive element 522 is depicted in FIG. 7B as a single element, the WTRU 502 may include any number of transmit/receive elements 522. More specifically, the WTRU 502 may employ MIMO technology. Thus, in one embodiment, the WTRU 502 may include two or more transmit/receive elements 522 (e.g., multiple antennas) for transmitting and receiving wireless signals over the air interface 515/516/517.

The transceiver 520 may be configured to modulate the signals that are to be transmitted by the transmit/receive element 522 and to demodulate the signals that are received by the transmit/receive element 522. As noted above, the WTRU 502 may have multi-mode capabilities. Thus, the transceiver 520 may include multiple transceivers for enabling the WTRU 502 to communicate via multiple RATs, such as UTRA and IEEE 802.11, for example.

The processor 518 of the WTRU 502 may be coupled to, and may receive user input data from, the speaker/microphone 524, the keypad 526, and/or the display/touchpad 528 (e.g., a liquid crystal display (LCD) display unit or organic light-emitting diode (OLED) display unit). The processor 518 may also output user data to the speaker/microphone 524, the keypad 526, and/or the display/touchpad 528. In addition, the processor 518 may access information from, and store data in, any type of suitable memory, such as the non-removable memory 530 and/or the removable memory 532. The non-removable memory 530 may include random-access memory (RAM), read-only memory (ROM), a hard disk, or any other type of memory storage device. The removable memory 532 may include a subscriber identity module (SIM) card, a memory stick, a secure digital (SD) memory card, and the like. In other embodiments, the processor 518 may access information from, and store data in, memory that is not physically located on the WTRU 502, such as on a server or a home computer (not shown).

The processor 518 may receive power from the power source 534, and may be configured to distribute and/or control the power to the other components in the WTRU 502. The power source 534 may be any suitable device for powering the WTRU 502. For example, the power source 534 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 518 may also be coupled to the GPS chipset 536, which may be configured to provide location information (e.g., longitude and latitude) regarding the current location of the WTRU 502. In addition to, of in lieu of, the information front the GPS chipset 536, the WTRU 502 may receive location information over the air interface 515/516/517 from a base station (e.g., base stations 514a, 514b) and/or determine its location based on the timing of the signals being received from two or more nearby base stations. It will be appreciated that the WTRU 502 may acquire location information by way of any suitable location-determination method while remaining consistent with an embodiment.

The processor 518 may further be coupled to other peripherals 538, which may include one or more software and/or hardware modules that provide additional features, functionality and/or wired of wireless connectivity. For example, the peripherals 538 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit a digital music player, a media player, a video game player module, an Internet browser, and the like.

FIG. 7C is a system diagram of the RAN 503 and the core network 506 according to an embodiment. As noted above, the RAN 503 may employ a UTRA radio technology to communicate with the WTRUs 502a, 502b, 502c over the air interface 515. The RAN 504 may also be in communication with the core network 506. As shown in FIG. 7C, the RAN 503 may include Node-Bs 540a, 540b, 540c, which may each include one or more transceivers for communicating with the WTRUs 502a, 502b, 502c over the air interface 515. The Node-Bs 540a, 540b, 540c may each be associated with a particular cell (not shown) within the RAN 503. The RAN 503 may also include RNCs 542a, 542b. It will be appreciated that the RAN 503 may include any number of Node-Bs and RNCs while remaining consistent with an embodiment.

As shown in FIG. 7C, the Node-Bs 540a, 540b may be in communication with the RNC 542a. Additionally, the Node-B 540c may be in communication with the RNC 542b. The Node-Bs 540a, 540b, 540c may communicate with the respective RNCs 542a, 542b via an Iub interface. The RNCs 542a, 542b may be in communication with one another via an Iur interface. Each of the RNCs 542a, 542b may be configured to control the respective Node-Bs 540a, 540b, 540c to which it is connected. In addition, each of the RNCs 542a, 542b may be configured to carry out or support other functionality, such as outer loop power control, load control, admission control, packet scheduling handover control, macrodiversity, security functions, data encryption, and the like.

The core network 506 shown in FIG. 7C may include a media gateway (MGW) 544, a mobile switching center (MSC) 546, a serving GPRS support node (SGSN) 548, and/or a gateway GPRS support node (GGSN) 550. While each of the foregoing elements are depicted as part of the core network 506, it will be appreciated that any one of these elements may be owned and/or operated by an entity other than the core network operator.

The RNC 542a in the RAN 503 may be connected to the MSC 546 in the core network 506 via an IuCS interface. The MSC 546 may be connected to the MGW 544. The MSC 546 and the MGW 544 may provide the WTRUs 502a, 502b, 502c with access to circuit-switched networks, such as the PSTN 508, to facilitate communications between the WTRUs 502a, 502b, 502c and traditional land-line communications devices.

The RNC 542a in the RAN 503 may also be connected to the SGSN 548 in the core network 506 via an IuPS interface. The SGSN 548 may be connected to the GGSN 550. The SGSN 548 and the GGSN 550 may provide the WTRUs 502a, 502b, 502c with access to packet-switched networks, such as the Internet 510, to facilitate communications between and the WTRUs 502a, 502b, 502c and IP-enabled devices.

As noted above, the core network 506 tray also be connected to the networks 512, which may include other wired or wireless networks that are owned and/or operated by other service providers.

FIG. 7D is a system diagram of the RAN 504 and the core network 507 according to another embodiment. As noted above, the RAN 504 may employ an E-UTRA radio technology to communicate with the WTRUs 502a, 502b, 502c over the air interface 516. The RAN 504 may also be in communication with the core network 507.

The RAN 504 may include eNode-Bs 560a, 560b, 560c, though it will be appreciated that the RAN 504 may include any number of eNode-Bs while remaining consistent with an embodiment. The eNode-Bs 560a, 560b, 560c may each include one or more transceivers for communicating with the WTRUs 502a, 502b, 502c over the air interface 516. In one embodiment, the eNode-Bs 560a, 560b, 560c may implement MIMO technology. Thus, the eNode-B 560a, for example, may use multiple antennas to transmit wireless signals to, and receive wireless signals from, the WTRU 502a.

Each of the eNode-Bs 560a, 560b, 560c may be associated with a particular cell (not shown) and may be configured to handle radio resource management decisions, handover decisions, scheduling of users in the uplink and/or downlink, and the like. As shown in FIG. 7D, the eNode-Bs 560a, 560b, 560c may communicate with one another over an X2 interface.

The core network 507 shown in FIG. 7D may include a mobility management gateway (MME) 562, a serving gateway 564, and a packet data network (PDN) gateway 566. While each of the foregoing elements are depicted as part of the core network 507, it will be appreciated that any one of these elements may be owned and/or operated by an entity other than the core network operator.

The MME 562 may be connected to each of the eNode-Bs 560a, 560b, 560c in the RAN 504 via an S1 interface and may serve as a control node. For example, the MME 562 may be responsible for authenticating users of the WTRUs 502a, 502b, 502c, bearer activation/deactivation, selecting a particular serving gateway during an initial attach of the WTRUs 502a, 502b, 502c, and the like. The MME 562 may also provide a control plane function for switching between the RAN 504 and other RANs (not shown) that employ other radio technologies, such as GSM or WCDMA.

The serving gateway 564 may be connected to each of the eNode Bs 560a, 560b, 560c in the RAN 504 via the S1 interface. The serving gateway 564 may generally route and forward user data packets to/from the WTRUs 502a, 502b, 502c. The serving gateway 564 may also perform other functions, such as anchoring user planes during inter-eNode B handovers, triggering paging when downlink data is available for the WTRUs 502a, 502b, 502c, managing and storing contexts of the WTRUs 502a, 502b, 502c, and the like.

The serving gateway 564 may also be connected to the PDN gateway 566, which may provide the WTRUs 502a, 502b, 502c with access to packet-switched networks, such as the Internet 510, to facilitate communications between the WTRUs 502a, 502b, 502c and IP-enabled devices.

The core network 507 may facilitate communications with other networks. For example, the core network 507 may provide the WTRUs 502a, 502b, 502c with access to circuit-switched networks, such as the PSTN 508, to facilitate communications between the WTRUs 502a, 502b, 502c and traditional land-line communications devices. For example, the core network 507 may include, or may communicate with, an IP gateway (e.g., an IP multimedia subsystem (IMS) server) that serves as an interface between the core network 507 and the PSTN 508. In addition, the core network 507 may provide the WTRUs 502a, 502b, 502c with access to the networks 512, which may include other wired or wireless networks that are owned and/or operated by other service providers.

FIG. 7E is a system diagram of the RAN 505 and the core network 509 according to another embodiment. The RAN 505 may be an access service network (ASN) that employs IEEE 802.16 radio technology to communicate with the WTRUs 502a, 502b, 502c over the air interface 517. As will be further discussed below, the communication links between the different functional entities of the WTRUs 502a, 502b, 502c, the RAN 505, and the core network 509 may be defined as reference points.

As shown in FIG. 7E, the RAN 505 may include base stations 580a, 580b, 580c, and an ASN gateway 582, though it will be appreciated that the RAN 505 may include any number of base stations and ASN gateways while remaining consistent with an embodiment. The base stations 580a, 580b, 580c may each be associated with a particular cell (not shown) in the RAN 505 and may each include one or more transceivers for communicating with the WTRUs 502a, 502b, 502c over the air interface 517. In one embodiment, the base stations 580a, 580b. 580c may implement MIMO technology. Thus, the base station 580a, for example, may use multiple antennas to transmit wireless signals to, and receive wireless signals from, the WTRU 502a. The base stations 580a, 580b, 580c may also provide mobility management functions, such as handoff triggering, tunnel establishment, radio resource management, traffic classification, quality of service (QoS) policy enforcement, and the like. The ASN gateway 582 may serve as a traffic aggregation point and may be responsible for paging, caching of subscriber profiles, routing to the core network 509, and the like.

The air interface 517 between the WTRUs 502a, 502b, 502c and the RAN 505 may be defined as an R1 reference point that implements the IEEE 802.16 specification. In addition, each of the WTRUs 502a, 502b, 502c may establish a logical interface (not shown the core network 509. The logical interface between the WTRUs 502a. 502b, 502c and the core network 509 may be defined as an R2 reference point, which may be used for authentication, authorization, IP host configuration management, and/or mobility, management.

The communication link between each of the base stations 580a, 580b, 580c may be defined as an R8 reference point that includes protocols for facilitating WTRU handovers and the transfer of data between base stations. The communication link between the base stations 190a, 580b, 580c and the ASN gateway 582 may be defined as an R6 reference point. The R6 reference point may include protocols for facilitating mobility management based on mobility events associated with each of the WTRUs 502a, 502b, 502c.

As shown in FIG. 7E, the RAN 505 may be connected to the core network 509. The communication link between the RAN 505 and the core network 509 may defined as an R3 reference point that includes protocols for facilitating data transfer and mobility management capabilities, for example. The core network 509 may include a mobile IP home agent (MIP-HA) 584, an authentication, authorization, accounting (AAA) server 586, and a gateway 588. While each of the foregoing elements are depicted as part of the core network 509, it will be appreciated that any one of these elements may be owned and/or operated by an entity other than the core network operator.

The MIP-HA 584 may be responsible for IP address management, and may enable the WTRUs 502a, 502b, 502c to roam between different ASNs and/or different core networks. The MIP-HA 584 may provide the WTRUs 502a, 502b, 502c with access to packet-switched networks, such as the Internet 510, to facilitate communications between the WTRUs 502a, 502b, 502c and IP-enabled devices. The AAA server 586 may be responsible for user authentication and for supporting user services. The gateway 588 may facilitate interworking with other networks. For example, the gateway 588 may provide the WTRUs 502a, 502b, 502c with access to circuit-switched networks, such as the PSTN 508, to facilitate communications between the WTRUs 502a, 502b, 502c and traditional land-line communications devices. In addition, the gateway 588 may provide the WTRUs 502a, 502b, 502c with access to the networks 512, which may include other wired or wireless networks that are owned and/or operated by other service providers.

Although not shown in FIG. 7E, it will be appreciated that the RAN 505 may be connected to other ASNs and the core network 509 may be connected to other core networks. The communication link between the RAN 505 the other ASNs may be defined as an R4 reference point, which may include protocols for coordinating the mobility of the WTRUs 502a, 502b, 502c between the RAN 505 and the other ASNs. The communication link between the core network 509 and the other core networks may be defined as an R5 reference, which may include protocols for facilitating interworking between home core networks and visited core networks.

The processes described above may be implemented in a computer program, software, and/or firmware incorporated in a computer-readable medium for execution by a computer and/or processor. Examples of computer-readable media include, but are not limited to, electronic signals (transmitted over wired and/o wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

1-12. (canceled)

13. A method for determining user presence in a mobile device, the method comprising:
detecting a face;
determining a face distance associated with the detected face;
determining a motion status associated with the mobile device; and
confirming a user presence based at least on the face distance and the motion status.

14. The method of claim 13, wherein the face distance is determined based on one or more of an interpupillary distance, a camera view angle, an angle between eyes, or an angle capturing head breadth.

15. The method of claim 13, wherein the motion status indicates whether the mobile device is in motion or at rest.

16. The method of claim 13, wherein the motion status is determined using one or more sensors in the mobile device.

17. The method of claim 13, wherein confirming the user presence further comprises determining a distance threshold and comparing the distance threshold to the face distance.

18. The method of claim 17, wherein the distance threshold is determined based on the motion status.

19. The method of claim 13, further comprising:
determining an orientation associated with the mobile device; and
confirming the user presence, wherein the user presence is based at least on the face distance, the orientation, and the motion status.

20. A mobile device comprising:
a processor configured to:
detect a face;
determine a face distance associated with the detected face;
determine a motion status associated with the mobile device; and
confirm a user presence based at least on the face distance and the motion status.

21. The mobile device of claim 20, wherein the face distance is determined based on one or more of an interpupillary distance, a camera view angle, an angle between eyes, or an angle capturing head breadth.

22. The mobile device of claim 20, wherein the motion status indicates whether the mobile device is in motion or at rest.

23. The mobile device of claim 20, wherein the motion status is determined using one or more sensors in the mobile device.

24. The mobile device of claim 20, wherein to confirm the user presence, the processor is further configured to determine a distance threshold and compare the distance threshold to the face distance.

25. The mobile device of claim 24, wherein the distance threshold is determined based on the motion status.

26. The mobile device of claim 20, wherein the processor is further configured to:
determine an orientation associated with the mobile device; and
confirm the user presence based, wherein the user presence is confirmed based at least on the face distance, the orientation, and the motion status.
